(19) United States
(12) Patent Application Publication
(10) Pub. No.: US 2025/0045822 A1
(43) Pub. Date: Feb. 6, 2025

(54) SYSTEMS AND METHODS FOR COMPUTING CREDIT SCORING FOR ORGANIZATIONS BASED ON NEURAL NETWORK ARCHITECTURES

(71) Applicant: AVENEWS-GT LTD, Tel Aviv (IL)

(72) Inventors: Ismael KHAROUB, Tel Aviv-Yafo (IL); Muhamad ARAR, Tel Aviv-Yafo (IL)

(21) Appl. No.: 18/794,042

(22) Filed: Aug. 5, 2024

Related U.S. Application Data
(60) Provisional application No. 63/530,478, filed on Aug. 3, 2023.

(51) Int. Cl. G06Q 40/03

(52) U.S. Cl. CPC G06Q 40/03

(57) ABSTRACT

A method for computing an organization's credit score, the method comprises collecting sequential data of the organization; processing the sequential data using a Sequential Deep Neural Network (SDNN) computer model such that the SDNN computer model outputs a first credit score value; collecting non-sequential data of the organization; processing the non-sequential data using a Convolutional Neural Network (CNN) computer model such that the CNN computer model outputs a second credit score value; computing a total credit score based on the first credit score value and the second credit score value.

### FIELD

The invention relates generally to computerized systems and processes for computing credit scoring for organizations based on neural network architectures.

### BACKGROUND

An organization's financial credit score refers to the potential for monetary loss or instability that can arise from various sources. These credit scores can impact an organization's ability to achieve its financial objectives and sustain operations.

To compute and manage financial credit scores, organizations commonly use a range of practices and methodologies, such as risk assessment and identification, quantitative analysis, Value at Risk, Stress Testing, Sensitivity Analysis, and the like. However, these techniques fail to accurately utilize processes and computer architectures used in machine learning.

### SUMMARY

In one aspect of the invention a method is provided for computing an organization's credit score, the method comprising collecting sequential data of the organization; processing the sequential data using a Sequential Deep Neural Network (SDNN) computer model such that the SDNN computer model outputs a first credit score value; collecting non-sequential data of the organization; processing the non-sequential data using a Convolutional Neural Network (CNN) computer model such that the CNN computer model outputs a second credit score value; computing a total credit score based on the first credit score value and the second credit score value.

In some cases, the SDNN computer model comprises an input layer for receiving the sequential data; multiple hidden layers employing ReLU activation functions; an output layer with a sigmoid activation function to generate a credit score.

In some cases, wherein the CNN computer model comprises multiple convolutional layers configured to extract key features from the non-sequential data; pooling layers configured to reduce dimensionality, and fully connected layers with ReLU activation functions to further process the non-sequential data.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a method for computing a credit score for an organization, according to exemplary embodiments of the invention; and

FIG. 2 shows computerized components of a system for computing a credit score for an organization, according to exemplary embodiments of the invention.

### DETAILED DESCRIPTION

The invention, in embodiments thereof, provides methods and techniques for computing credit scoring using computerized models that are tailored specifically for agricultural organizations, more specifically to small and medium agricultural organizations (agri-SMEs). The model is constructed by leveraging the combined power of Sequential Deep Neural Network (SDNN) and Convolutional Neural Network (CNN) architectures. The model may be implemented utilizing the Keras library in Python. The SDNN will effectively process sequential data related to the agri-SMEs' operational and financial metrics, while the CNN will handle non-sequential categorical data, offering a comprehensive approach to credit assessment.

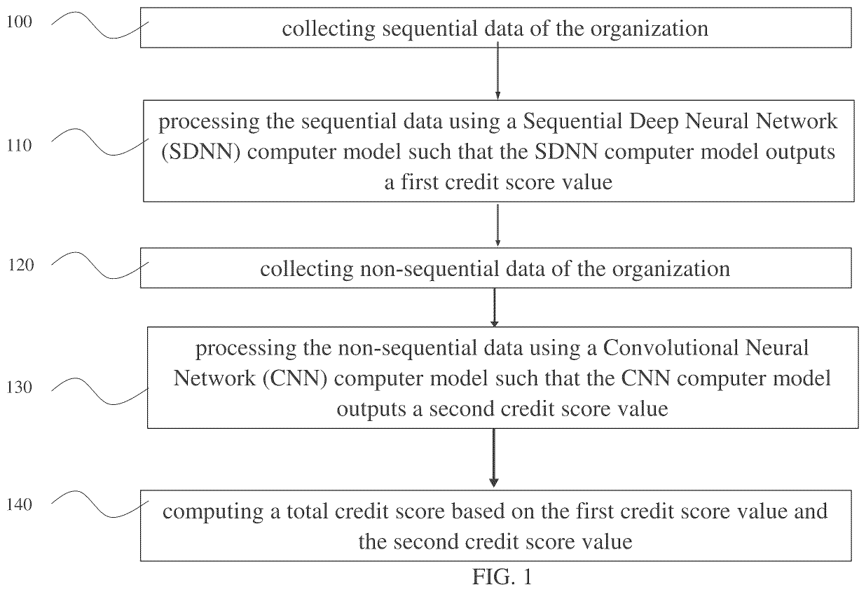

FIG. 1 shows a method for computing a credit score for an organization, according to exemplary embodiments of the invention.

Step 100 discloses collecting sequential data of the organization.

Step 110 discloses processing the sequential data using a Sequential Deep Neural Network (SDNN) computer model such that the SDNN computer model outputs a first credit score value.

Step 120 discloses collecting non-sequential data of the organization.

Step 130 discloses processing the non-sequential data using a Convolutional Neural Network (CNN) computer model such that the CNN computer model outputs a second credit score value.

Step 140 discloses computing a total credit score based on the first credit score value and the second credit score value.

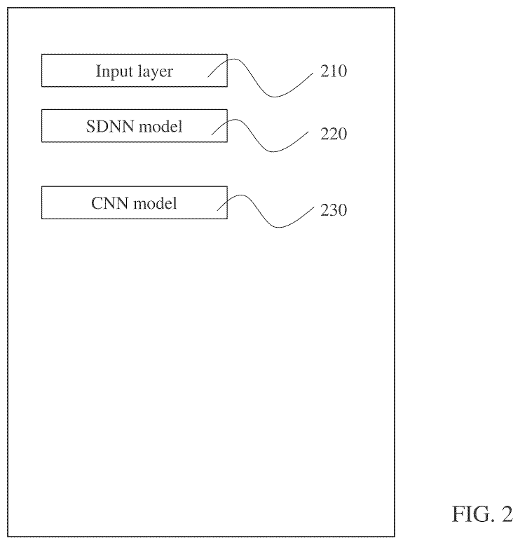

FIG. 2 shows computerized components of a system for computing a credit score for an organization, according to exemplary embodiments of the invention. The system comprises an input unit 210 configured to collect information into the model. The system also comprises a Sequential Deep Neural Network (SDNN) model 220 and a Convolutional Neural Network (CNN) model 230.

The invention, in embodiments thereof, provides a process of generating the Sequential Deep Neural Network (SDNN). The SDNN will be created to analyze and extract insights from the sequential data pertinent to agricultural organizations. Such data include factors such as the organization's operating tenure, last month's total income, seasonality patterns, transaction history, and other time-based series of financial information. The SDNN model will be structured with an input layer to receive this sequential data, which may be followed by two hidden layers using Rectified Linear (ReLU) activation functions. These hidden layers are designed to identify and capture intricate patterns within the data. Finally, the model may have an output layer equipped with a sigmoid activation function, enabling the model to yield a credit score that ranges between 0 and 1.

The invention, in embodiments thereof, provides a process of constructing the Convolutional Neural Network (CNN). The CNN may be created to handle non-sequential categorical data associated with agricultural organizations' business operations. This data includes information such as the type of supply, business registration type, market trends, and the nature of crops or livestock involved. The CNN model will be comprised of a convolutional layer, which will effectively identify and extract crucial features from the categorical data. Following the identification and extraction of features, a pooling layer may be used to reduce the dimensionality and computational complexity, while a flattening operation will prepare the data for the fully connected layers. The CNN model will include two fully connected layers using ReLU activation functions, further processing the data, and an output layer with a sigmoid activation function to generate the credit score.

The SDNN and CNN models may be compiled using a logic function, such as the mean squared error loss function, appropriate for regression problems like credit scoring. Additionally, the Adam optimizer, known for its efficiency and effectiveness in training deep learning models, may be employed to enhance the learning process of the models.

The invention, in embodiments thereof, thus suggests a fully operational credit scoring model specifically designed for agricultural organizations. This model will effectively utilize the operational and financial data to generate a numerical credit score. The implementation of this credit scoring model is projected to significantly expedite the credit approval process, which currently takes 7-9 days and relies heavily on human evaluation. Given an average of 120 credit requests per week, this novel model holds the potential to substantially enhance the efficiency of credit assessment, improve the overall customer experience, and provide a more precise and equitable credit scoring mechanism for agricultural organizations.

In some exemplary embodiments, the model may be used for computing a credit score for business expansion. In this scenario, an agricultural organization with a 5-year history aims to expand its organic vegetable supply business. Seeking a loan from another organization, the agricultural organization's creditworthiness will be assessed using a proprietary model that combines Sequential Deep Neural Network (SDNN) and Convolutional Neural Network (CNN) architectures.

The SDNN will process the sequential data, such as 5 years of operation, the organization's last month's income, business seasonality, and transaction history. Meanwhile, the CNN model will handle non-sequential data, including organic vegetable supply, private limited company registration, and market trends.

The models will provide a credit score between 0 and 1, enabling the other organization to make a quick and informed loan decision. The accelerated process empowers the agricultural organization to seize the business opportunity promptly while ensuring equitable lending decisions for the other organization and the agriculture sector.

The invention, in embodiments thereof, provides integrating Sequential and Non-Sequential Data. The primary innovation lies in developing a credit scoring model that seamlessly combines sequential and non-sequential data from agricultural organizations, such as farms, cooperatives, companies, packing houses, NGOs and the like. Integrating operational and financial time-series data with categorical information is a technological challenge, requiring the optimization of the Sequential Deep Neural Network (SDNN) and Convolutional Neural Network (CNN) architectures. Overcoming the complexity of processing diverse data types and ensuring their effective fusion is a crucial technological challenge.

The invention, in embodiments thereof, provides model optimization for precise credit scoring. Achieving accurate credit scoring for agricultural organizations requires careful model optimization. The invention, in embodiments thereof, provides selecting appropriate activation functions and hidden layers for the SDNN and CNN components. Additionally, The invention, in embodiments thereof, provides fine-tuning values of hyperparameters and choosing the optimal loss function for regression problems like credit scoring. Striking the right balance between interpretability and predictive power is a significant challenge in ensuring the model's robustness and reliability.

The invention, in embodiments thereof, provides handling limited data and generalization. Agricultural organizations often have limited historical data, making it challenging for the model to generalize accurately. The invention, in embodiments thereof, provides building a credit scoring model with broader applicability by addressing parameters such as overfitting and underfitting. Addressing the issue of data scarcity while maintaining the model's ability to provide reliable credit scores poses a notable innovation. The invention, in embodiments thereof, provides utilizing techniques such as data augmentation, transfer learning, and regularization methods to enhance model performance with limited data availability.

The invention, in embodiments thereof, provides integrating and fusing sequential and non-sequential data from diverse sources within agricultural organizations. The invention, in embodiments thereof, provides harmonizing operational and financial time-series data with categorical information while maintaining data integrity and relevance. Ensuring seamless data processing between the Sequential Deep Neural Network (SDNN) and Convolutional Neural Network (CNN) components involves innovative techniques to handle varying data types cohesively.

The invention, in embodiments thereof, provides designing an optimal model architecture that can leverage the combined power of SDNN and CNN architectures. Designing the optimal model involves determining the most effective configuration of hidden layers, activation functions, and the number of fully connected layers. Achieving a balance between model complexity and interpretability is critical to creating a functional credit scoring model that accurately analyzes agricultural organizations' unique characteristics.

The invention, in embodiments thereof, provides tailoring the credit scoring model specifically for agricultural organizations that have unique operational and financial metrics, necessitating the development of a model that can effectively capture their characteristics. Ensuring that the model comprehensively assesses the creditworthiness of agricultural organizations, while maintaining accuracy and fairness, will be crucial in gaining a competitive edge over generic credit scoring models.

The invention, in embodiments thereof, offers a competitive advantage in credit assessment using the combined power of SDNN and CNN architectures. The invention, in embodiments thereof, provides running the combined model multiple times using a target function to achieve the right balance between model complexity and computational efficiency. The model performs efficiently without compromising on accuracy and robustness. Streamlining the computational requirements while providing high-quality credit-scoring results is a critical aspect of the model.

The invention, in embodiments thereof, provides a credit scoring model that can rapidly process data and provide credit scores in real time. Reducing the current credit approval process from 7-9 days to near-instantaneous decisions requires innovative strategies to optimize the model's performance and minimize processing time. Providing faster credit assessments can enhance customer experience and position the model as a preferred choice for agricultural organizations seeking timely financial support.

The invention, in embodiments thereof, provides developing a dynamic credit limit algorithm utilizing machine learning. The algorithm may be developed utilizing machine learning techniques to adjust credit limits for retailers based on the agricultural organizations' creditworthiness, financial behavior, and credit scores derived from a proprietary credit scoring model. The algorithm may be implemented using the scikit-learn library in Python, to enhance the credit limit management process, providing retailers with more dynamic and fair credit limits tailored to their individual circumstances.

The invention, in embodiments thereof, provides processing sequential and non-sequential data to create the dynamic credit limit algorithm. The algorithm analyzes sequential data, including the retailer's financial behavior, payment history, and other time-series data. Simultaneously, the algorithm considers non-sequential data, such as the business size and seasonality of the business. This comprehensive approach will enable us to capture intricate patterns and relevant insights necessary to determine appropriate credit limits for retailers.

The invention, in embodiments thereof, provides processes for model construction and optimization. The algorithm may be constructed using machine learning models, such as regression or decision tree models, within the scikit-learn framework. The model's design may involve an input layer to receive the processed data, and one or more hidden layers equipped with ReLU activation functions to capture complex relationships in the data. The output layer may be equipped with a linear activation function to produce a credit limit value. To optimize the model's performance, the model may be compiled with a mean squared error loss function, tailored for regression problems like credit limit prediction. The renowned Adam optimizer may be employed to enhance training efficiency and model performance.

In an exemplary use case, a small agricultural inputs retailer with a 3-year operational history that specializing in seeds, fertilizers, and avocado saplings, and is registered as a sole proprietorship. The retailer inputs have maintained a steady income growth, with the latest month's total income recorded at KES 2,000,000. The organization's payment history is impeccable, demonstrating responsible financial behavior. Additionally, the business exhibits seasonality, witnessing higher sales during planting seasons. The retailer Inputs is an active credit client with the financial organization that may issue credit to the agricultural organizations, and the dynamic credit limit algorithm comes into play when significant market events occur. Notably, there is an abrupt increase in the price of certain fertilizers due to a shortage, offering retailers an opportunity for increased profits by stocking these fertilizers. For example, the Kenyan government imposes a temporary ban on avocados, impacting the sales of avocado saplings provided by the organization's Inputs. The dynamic credit limit algorithm processes relevant sequential data, including payment history, income growth, operational duration, alongside non-sequential data like the type of supply (seeds, fertilizers, and avocado saplings), business registration type (sole proprietorship), seasonality, and current market trends and government policies.

Considering the market dynamics, the algorithm proactively increases the organization's inputs' credit limit, enabling them to immediately procure and stock the in-demand fertilizers, capitalizing on the profitable opportunity. Simultaneously, to mitigate the risk associated with the imposed avocado ban, the algorithm slightly reduces the credit limit for the purchase of avocado saplings. This dynamic adjustment allows the organization's inputs to promptly plan their operations and make informed financial decisions.

The invention, in embodiments thereof, provides integrating heterogeneous data sources. One of the key innovation aspects of the invention lies in effectively processing and integrating both sequential and non-sequential data. This involves combining diverse data types, including financial behavior, payment history, time-series data, business size, and seasonality. The invention, in embodiments thereof, provides algorithms that can seamlessly handle this heterogeneous data to extract meaningful patterns and insights for credit limit adjustments demands using advanced data processing and machine learning techniques.

The invention, in embodiments thereof, provides processes for model optimization and complexity management. The processes include constructing a dynamic credit limit algorithm using machine learning models that require optimizing the model's performance and managing the model's complexity. Selecting appropriate machine learning algorithms, such as regression or decision tree models, and designing the architecture with relevant hidden layers and activation functions are crucial for accurate credit limit prediction. Furthermore, striking the right balance between model complexity and computational efficiency is essential to ensure the algorithm can handle real-time credit limit adjustments while maintaining accuracy and fairness. Managing the trade-offs between model performance and computational resources poses a significant technological challenge.

The invention, in embodiments thereof, provides a process of comprehensive data integration that includes developing a dynamic credit limit algorithm that processes both sequential and non-sequential data and presents a functional innovation challenge. Integrating diverse data types, such as financial behavior, payment history, time-series data, business size, and seasonality, provides a robust approach to ensure seamless data integration and capture relevant insights necessary for accurate credit limit adjustments. Implementing an efficient and cohesive data processing mechanism is critical to achieving a comprehensive view of retailers' creditworthiness.

The invention, in embodiments thereof, provides a process of real-time credit limit adjustment which includes enabling real-time credit limit adjustments for retailers based on dynamic factors such as market events and government policies. The algorithm needs to respond promptly to updated circumstances to provide retailers with immediate and fair credit limit updates. The invention, in embodiments thereof, provides an agile and responsive system that efficiently recalculates credit limits while maintaining accuracy and reliability in order to meet the demands of the credit management process effectively.

The invention, in embodiments thereof, provides a process of advanced data analysis and extraction of insights. The process includes developing a dynamic credit limit algorithm that requires harnessing the power of machine learning techniques to process both sequential and non-sequential data effectively. The invention, in embodiments thereof, provides leveraging these techniques to extract sophisticated insights from diverse data sources, enabling the algorithm to make accurate and timely credit limit adjustments. Gaining a deeper understanding of retailers' creditworthiness and financial behavior through comprehensive data analysis is crucial to staying ahead in the dynamic credit management landscape.

The invention, in embodiments thereof, provides a process of real-time decision-making and adaptability to changing market conditions. Rapidly processing incoming data and adjusting credit limits promptly based on evolving factors such as market trends and government policies is critical for providing retailers with dynamic and fair credit limits. Ensuring the algorithm's responsiveness and flexibility in a fast-paced business environment is essential to delivering a superior credit management experience and maintaining a competitive advantage in the industry.

The invention, in embodiments thereof, provides a process of Enhancing Creditworthiness of organizations using AI Personalization Algorithm. The process Empowers agricultural organizations with Tailored Financial Strategies.

The invention, in embodiments thereof, provides using a robust AI personalization algorithm to assist potential agricultural organizations (Small and Medium Enterprises) in adopting financial behaviors that enhance their creditworthiness. The model leverages a combination of Collaborative Filtering (CF) and Content-Based Filtering (CBF) techniques to analyze the financial and operational contexts of these businesses, ultimately providing personalized financial recommendations aligned with a financial institute that wishes to obtain credit assessment parameters.

The invention, in embodiments thereof, provides the collaborative filtering component of the AI algorithm. The model analyzes historical data patterns and trends of successfully creditworthy agricultural organizations that share similar financial and operational profiles. By constructing a user-item matrix and applying matrix factorization techniques, the model identifies key financial strategies that have contributed to the creditworthiness of agricultural organizations wishing to receive credit. The resulting insights will be utilized to generate personalized recommendations for the target agricultural organizations, aligning their financial practices with proven successful models.

The invention, in embodiments thereof, provides the content-based filtering component of the AI algorithm. This process focuses on the specific financial behaviors and operational strategies of each agricultural organization. By scrutinizing essential financial indicators such as transaction history, timely credit repayment, consistent profitability, and effective risk management, the algorithm generates tailored recommendations. These recommendations will be based on aligning the agricultural organizations' financial practices with successful behavior patterns that have led to creditworthiness in similar cases.

The AI model may be created using Python programming language and various data science libraries such as pandas, NumPy, and scikit-learn. These tools enable efficient handling and analyze the data, build the AI algorithm, and assess its performance using precision and recall metrics. The system of the invention, in embodiments thereof, reviews the model's effectiveness in providing accurate and relevant personalized financial recommendations to prospective agricultural organizations, guiding them on their path to enhanced creditworthiness and eligibility for Avenews' credit products.

For example, an agricultural organization has been operating for a duration of 3 years, specializing in the distribution of poultry and dairy products. Currently, the agricultural organization does not meet the financial institute's creditworthiness criteria. However, there is chance for improvement. To assist the agricultural organization in enhancing their creditworthiness, the AI personalization algorithm employs two distinct techniques: Collaborative Filtering and Content-Based Filtering. Through Collaborative Filtering, the algorithm examines the financial behaviors of similar agricultural organizations (having similar characteristics, such as size, type, geography, EGS and the like) that have achieved improved creditworthiness. The algorithm identifies common patterns, such as consistent transaction records, timely repayments, and sustained profitability, and recommends these strategies to the agricultural organization. Concurrently, in the Content-Based Filtering phase, the algorithm delves into the specific financial practices of the agricultural organization. The analysis reveals that the company demonstrates steady profitability but encounters challenges with timely credit repayments. To address this issue, the algorithm offers personalized recommendations, such as creating a dedicated repayment fund from their monthly profits. By implementing these tailored recommendations, the agricultural organization can work towards strengthening its creditworthiness and increasing its eligibility for potential debt owners' credit products. This AI-driven and personalized approach not only benefits the agricultural organizations but also enhances the financial institute's potential customer base and reinforces its position within the agricultural credit market.

The invention, in embodiments thereof, provides the integration of collaborative and content-based filtering techniques. The development of a robust AI personalization algorithm that seamlessly combines Collaborative Filtering (CF) and Content-Based Filtering (CBF) techniques. Integrating these two distinct methodologies requires careful consideration of data preprocessing, feature engineering, and model fusion. Ensuring effective collaboration between CF and CBF components to provide accurate and personalized financial recommendations for agricultural organizations.

The invention, in embodiments thereof, provides handling complex financial and operational data from diverse agricultural organizations. The algorithm efficiently processes and analyzes large volumes of data, encompassing transaction history, credit repayment patterns, profitability trends, risk management practices, and more. Dealing with such intricate and varied datasets demands sophisticated data science techniques, including matrix factorization, feature selection, and advanced data manipulation. The invention, in embodiments thereof, outputs precise and actionable recommendations to agricultural organizations, fostering their creditworthiness and alignment with the financial institute's credit assessment parameters.

The invention, in embodiments thereof, provides techniques for algorithm fusion for personalized recommendations. The invention, in embodiments thereof, integrates Collaborative Filtering (CF) and Content-Based Filtering (CBF) techniques to develop an AI personalization algorithm. The effective fusion of these methodologies requires careful consideration of data processing, feature engineering, and model integration. Ensuring seamless collaboration between CF and CBF components to generate personalized financial recommendations for agricultural organizations poses a functional innovation in algorithm design and implementation.

The invention, in embodiments thereof, provides handling diverse financial and operational data from potential agricultural organizations. The algorithm analyzes and processes a wide range of data, including historical patterns, transaction history, credit repayment behavior, profitability trends, and risk management strategies. Dealing with such heterogeneous and complex datasets uses innovative data science techniques, such as matrix factorization and feature selection. The invention, in embodiments thereof, provides relevant and actionable financial recommendations that enhance creditworthiness and align with the financial institute's credit assessment parameters for agricultural organizations.

The invention, in embodiments thereof, provides extracting personalized financial insights from diverse and dynamic data sources of individual agricultural organizations. The algorithm processes extensive historical patterns, transaction data, and multiple financial indicators to provide personalized recommendations. Achieving this level of granularity and accuracy in financial behavior analysis differentiates the AI model, hence offering agricultural organizations highly relevant and actionable financial guidance. This provides great value for agricultural organizations seeking personalized credit solutions and enhancing their creditworthiness.

The invention, in embodiments thereof, boosts financial inclusivity for agricultural organizations by developing a USSD (Unstructured Supplementary Service Data) version of an online platform, catering to the needs of agricultural organizations with limited or unstable internet connectivity. By providing offline functionality through USSD, the invention, in embodiments thereof, enhances user experience, promotes financial inclusivity, and expands its user base.

The invention, in embodiments thereof, provides mapping online features to USSD-based menus and commands. This involves designing and developing USSD scripts that accurately replicate the functionalities available on an online platform. By ensuring seamless transitions between online and USSD-based services, the model provides a consistent and user-friendly experience for agricultural organizations accessing our services.

The invention, in embodiments thereof, provides integrating with telecom operators and USSD gateway implementation to establish real-time communication sessions over GSM network channels, allowing users to interact with a financial institute's platform without relying on internet connectivity. The system implements the USSD gateway, connecting directly to our API, to ensure smooth and efficient data exchange. For example, consider an agricultural organization operating in a region with limited and unreliable internet connectivity. As a livestock sales business, the agricultural organization heavily relies on accessing the financial institute's platform for their day-to-day operations. With the successful implementation of USSD functionality, the agricultural organization gains the advantage of accessing the financial institute's platform offline. For instance, if the agricultural organization needs to inquire about its current credit limit, a simple dialing of the USSD code followed by the command for “Check Credit Limit” provides the agricultural organization with instant access to its credit status. Furthermore, when presented with a potential opportunity, such as a rise in cattle prices due to increased demand, the agricultural organization can take prompt action by initiating a credit limit increase request through the USSD platform. This request is processed in real-time through a seamless API connectivity.

The invention, in embodiments thereof, provides USSD offline functionality for agricultural organizations. The primary innovation challenge lies in developing a robust USSD (Unstructured Supplementary Service Data) version of the online platform to cater to the specific needs of agricultural organizations with limited or unstable internet connectivity. This involves providing offline functionality through USSD to enhance user experience, promote financial inclusivity, and expand the user base. The invention, in embodiments thereof, seamlessly replicates the functionalities available on the online platform into USSD-based menus and commands, enabling agricultural organizations to access critical financial services even in areas with unreliable internet access.

The invention, in embodiments thereof, provides real-time integration and data exchange. The invention, in embodiments thereof, establishes real-time communication sessions over GSM network channels using a robust USSD gateway implementation, connecting directly to the platform's API, to ensure smooth and efficient data exchange. This way, the invention, in embodiments thereof, enables agricultural organizations to interact with the financial institute's platform without relying on internet connectivity while ensuring reliable functionality, accurate data handling, and up-to-date records.

The invention, in embodiments thereof, provides USSD offline functionality for enhanced access. The key functional innovation is providing a USSD version of the online platform, catering to the unique needs of agricultural organizations with limited or unstable internet connectivity. By offering offline functionality through USSD, the platform significantly enhances user experience, promotes financial inclusivity, and extends the platform's reach to agricultural organizations in regions with unreliable internet access. This allows agricultural organizations to interact with financial institutes' services seamlessly, regardless of their internet situation.

The invention, in embodiments thereof, provides the seamless replication of online features by mapping all the online features of the platform to USSD-based menus and commands. This involves designing and developing USSD scripts that accurately replicate the functionalities available on the online platform. By ensuring seamless transitions between online and USSD-based services, the aim is to create a consistent and user-friendly experience for agricultural organizations accessing Avenews' services. As demonstrated in the use case of “Healthy Herd Ltd.,” users can conveniently perform essential tasks, such as checking their credit limit and initiating credit limit increase requests, using simple USSD commands, fostering operational efficiency and financial management.

The invention, in embodiments thereof, provides enhanced accessibility and financial inclusivity by developing a USSD version of the online platform providing financial institutes with a competitive advantage by catering to the unique needs of agricultural organizations facing limited or unstable internet connectivity. By offering offline functionality through USSD, financial institutes significantly enhance user experience and promote financial inclusivity. Agricultural organizations can access essential financial services seamlessly, irrespective of their internet situation, enabling them to efficiently manage their businesses and make timely decisions.

The invention, in embodiments thereof, provides real-time and reliable connectivity. The integration with telecom operators and the implementation of the USSD gateway establishes real-time communication sessions over GSM network channels. This ensures that agricultural organizations using financial institutes' USSD-based interface experience reliable functionality, accurate data handling, and up-to-date records. With real-time processing of USSD commands through the API, agricultural organizations can access critical information and initiate credit limit increase requests promptly. This competitive advantage not only improves operational efficiency for agricultural organizations but also strengthens financial institutes' reputation as a reliable and accessible financial service providers in the agricultural sector.

FIG. 1 shows a system architecture for computing a credit score

Although the invention has been described in conjunction with specific embodiments thereof, it is evident that many alternatives, modifications, and variations will be apparent to those skilled in the art. Accordingly, it is intended to embrace all such alternatives, modifications, and variations that fall within the spirit and broad scope of the invention.

All publications, patents, and patent applications mentioned in this specification are herein incorporated in their entirety by reference into the specification, to the same extent as if each individual publication, patent, or patent application was specifically and individually indicated to be incorporated herein by reference. In addition, citation or identification of any reference in this application shall not be construed as an admission that such reference is available as prior art to the invention. To the extent that section headings are used, they should not be construed as necessarily limiting.

What is claimed is:

1. A method for computing an organization's credit score, the method comprises:
collecting sequential data of the organization;
processing the sequential data using a Sequential Deep Neural Network (SDNN) computer model such that the SDNN computer model outputs a first credit score value;
collecting non-sequential data of the organization;
processing the non-sequential data using a Convolutional Neural Network (CNN) computer model such that the CNN computer model outputs a second credit score value; and
computing a total credit score based on the first credit score value and the second credit score value.

2. The method of claim 1, wherein the SDNN computer model comprises:
an input layer for receiving the sequential data;
multiple hidden layers employing ReLU activation functions; and
an output layer with a sigmoid activation function to generate a credit score.

3. The method of claim 1, wherein the CNN computer model comprises:
multiple convolutional layers configured to extract key features from the non-sequential data; and
pooling layers configured to reduce dimensionality, and fully connected layers with ReLU activation functions to further process the non-sequential data.
